(19) United States
(12) Patent Application Publication
(10) Pub. No.: US 2013/0025180 A1
(43) Pub. Date: Jan. 31, 2013

(54) Security Container for Fishing Rods

(71) Applicants: Nicholas Norman, Hamilton, GA (US); John Vernon Rodgers, Hamilton, GA (US)

(72) Inventors: Nicholas Norman, Hamilton, GA (US); John Vernon Rodgers, Hamilton, GA (US)

(21) Appl. No.: 13/633,972

(22) Filed: Oct. 3, 2012

Related U.S. Application Data
(63) Continuation-in-part of application No. 13/052,268, filed on Mar. 21, 2011.

(51) Int. Cl. A01K 97/08; A01K 97/06

(52) U.S. Cl. 43/26

(57) ABSTRACT

A security box for a fishing rods and equipment is provided. The security box comprises four sidewalls, a bottom, and a hingedly attached lid. The lid lockably secures to a sidewall to prevent unauthorized access to the box's contents. Along the bottom of the box are a number of mounting holes and associated fasteners, so that the box can be removably secured to a large object like a boat or truck. Access to the mounting means is only available from within the box to keep thieves from stealing the box and its contents. A tackle box holder is disposed within the box to stop a tackle box from sliding around within the security box. Also provided is a set of cushioned inserts that protect the shafts of different styles of fishing rods and prevent them from banging into the walls of the box while the device is in transit.

### CROSS REFERENCE TO RELATED APPLICATION

This application claims the benefit of U.S. Provisional Application No. 61/316,957 filed on Mar. 24, 2010, entitled “Rod Locker” and from U.S. patent application Ser. No. 13/052,268 filed on Mar. 21, 2011, entitled “Rod Locker Box.” For the purpose of maintaining continuity of disclosure, the aforementioned applications are incorporated by reference herein.

### BACKGROUND OF THE INVENTION

### Field of the Invention

The present invention relates to a container for securing loose items. More specifically, it relates to a lockable box for securely retaining fishing rods and fishing tackle while the equipment is not in use. The box provides a means for securing fishing equipment to a large object such as the bed of a truck, to prevent theft of the equipment in between uses. The box thus eliminates the need for carrying smelly fishing equipment into a user's home for safekeeping.

Fishing is both a vocation and a hobby, enjoyed by people across the globe. The vast variety of fish that live in the Earth's waterways presents a seemingly limitless challenge to fishing enthusiasts and professional fishers alike. Methods of catching fish and styles of fishing vary almost as greatly as the fish themselves. Hobbyists often use a rod and reel set-up to catch fish individually, while commercial outfits use large nets to catch greater numbers of fish. The traditional rod and reel may be used to fish in any water environment but specialized rods, lines, lures, and bait has been developed to accommodate different conditions. Standard casting rods, and spinning rods have a smaller diameter than sea fishing/surf rods. Surf rods are longer than many other types of rods to assist a fisher with the long casts needed to land a lure past the break of the surf. On the other hand, deep-sea fishing rods are thick and strong , due to the larger size of fish in the deep ocean and the resultant need for a more robust line. Rods for ice fishing are also robust and thicker in diameter than a standard rod, but are far shorter than surf and sea rods, as there is little to no casting involved in the practice of ice fishing. Fly fishing rods are thin and lightweight with more flexibility than standard rods because casting is done by application of momentum rather than with the use of a lure to weight the line down. It is common for avid fishing enthusiasts to own several rods, each adapted for a different purpose. Ocean fishers may want both a surf and deep sea rod handy on their fishing trips so that they can fish off a boat, a pier, or from the beach, depending on weather conditions. Fishers who prefer lake and stream fishing might select a standard spin-casting rod and a fly rod for their outdoor excursions, so they can properly fish multiple types of water environments.

Organizing and securing fishing rods and tackle, particularly in transit, is a common problem for many fishermen. Rods that are placed loosely into a car or pick-up truck will slide around during transit, colliding with other items nearby. If the fishing line is left threaded on the rods during transit then the line can become entangled in parts of the car, truck, or other fishing equipment. Thinner, lightweight rods are particularly susceptible to being damaged during transport and can be cracked, or even broken during impacts with other objects. To solve this problem, some fishers secure pieces of PVC pipe to the grill of their vehicle and slide the butt of the rod down into the pipe. The fishing rods stand upright within the pipe during transport, preventing them from banging into each other, and airing them out in the breeze. Though this approach is effective for separating rods it poses the problem of leaving rods unsecured and available to dishonest people who can easily lift a rod free from a piece of piping and carry the rod away.

Theft is another common concern, as expensive equipment is often left unguarded when not in use. Fishing rods and tackle that are stored in grill-mounted piping or left in the bed of a truck can be carried away while the owner is not looking. Even rod carrying boxes do not provide security because the box itself can be lifted and carried away with the rods still in it. Hard truck bed covers provide protection to fishing rods and equipment, but do not solve the organizational problem. Additionally, such covers are only useful while the rods are within a truck bed. Once removed from the truck bed, the fishing equipment is once again susceptible to theft. A portable security box is needed that can contain and organize fishing rods and equipment, while securing the rods in place so that they can not be easily stolen when not in use.

### DESCRIPTION OF THE PRIOR ART

The present invention provides a security box adapted for holding fishing rods and fishing tackle. It has a hinged lid that locks to a sidewall of the box and several interior mounting holes for bolting the box to a car or truck bed from within the box. This ensures that the box cannot be removed from the car or truck by a person who does not have access to the inside of the box. The device also provides a tackle tray holder and a plurality of cushioned inserts that can be used to hold different types of fishing rods in place, and reduce the potential for damage to the rods while in transit. The prior art fails to disclose a security box having the unique structural elements or the functionality of the present invention.

Several devices have been suggested in the art for securing fishing rods and associated reels. U.S. Pat. No. 7,322,149 to Quintero describes a fishing rod organizer and container comprising two mateable halves that contain each rod's reel internal to the container and allow the rods to penetrate through cut-outs in an upper and lower section of each half. While this device is useful for organizing a series of rods and sheltering each rod's reel, there are no means described for securing the container to a larger structure, or a locking mechanism that would prevent one from stealing the rods out of the container.

U.S. Pat. No. 7,219,464 to Kujawa describes a locking storage system for fishing rods with a retention base. The retention base provides an insertion point for a plurality of fishing rod collars, with a sliding lock plate securing the assembly together. A pad lock or combination lock is used to secure the device and prevent theft. This device is very useful for horizontally stacking a series of fishing rods and locking them in place. However, the design does not provide any protection for the reels, which are exposed to the elements and possible theft. The reels can be damaged due to exposure, rust or contamination from other external debris sources.

U.S. Pat. No. 5,435,473 to Larkum describes another device for horizontally stacking a series of fishing rods. In this device, a plurality of vertical tubes is provided that accept the handle end of a fishing rod. A horizontal restraining bar stretches across each tube, and locks the fishing rods and the device together. A pad lock or combination lock is used to lock the restraining bar in place. The base of the device provides mounting points for attachment to a larger structure. Like the patent to Kujawa, this device only locks the rods in place and provides no protection for the reels.

U.S. Pat. No. 4,523,704 to Washington provides a fishing rod holder that is specifically suited for transport in a vehicle or by hand. A series of rods are housed in a carrier that encloses the reel of each rod. A hand portion and gutter mounts provide locations for transporting the device by hand or by car, respectively. While this device protects the reels of each rod and provides an organizing means for a series of rods, this device does not provide permanent attachment points for a larger structure to prevent theft.

None of these devices disclose a set of cushioned inserts that can be placed around the rod to protect it while in transit. Cushioned inserts buffer the rod from banging against the security box while the car or truck is in motion, thereby reducing the potential for damage to the rod. The inserts of the present invention have varied shapes to accommodate different types of fishing rods and offer a greater degree of equipment protection than the aforementioned prior art devices.

A solution is required that addresses the common drawbacks present in the art. Specifically, a fishing rod locker is required that provides containment of several fishing rods with an internal chamber for each reel to prevent damage, and one that provides mounting points to a larger structure to prevent theft. A locking mechanism for the internal chamber is also required. The following disclosure therefore remedies the shortcomings in the prior art by providing a device that meets these needs.

### SUMMARY OF THE INVENTION

In view of the foregoing disadvantages inherent in the known types of fishing rod lock boxes now present in the prior art, the present invention provides a new fishing rod lock box wherein the same can be utilized for providing convenience for the user when securing or transporting fishing equipment.

The present security box for fishing rods has four walls, a bottom, and a hingedly attached lid that locks to one of the sidewalls. Along the bottom of the box there are a number of holes to allow a securing means such as a bolt to pass through the bottom of the box. The bolt is inserted through the inside of the box and the box is secured in place from within the box. Thus when the top of the box is closed and locked, the interior is inaccessible and cannot be removed from the object it is secured to.

One wall of the security box has a plurality of apertures for the butt of a fishing rod handle to pass through, while the opposing wall of the box has several u-shaped cutouts for holding the shaft of a fishing rod. When the box is closed, the rod is held in place with the reel stored safely in the interior of the box. To prevent the rod from minor impacts with the sides of the cutouts, a set of cushioned inserts is included. A cushioned insert is slid down over each cutout to surround and buffer the shaft of the rod while it is stored within the box. These inserts are available in a variety of shapes to accommodate different styles and sizes of fishing rods.

A tackle box holder is disposed along one interior wall of the security box. The tackle box holder extends along the wall and may be a thick wire or a bracket. Tackle boxes of various sizes and shapes can be neatly stored within the box by sliding them down between the holder and the sidewall. Small items may be placed along the bottom of the box. In this way, the security box helps keep tackle and equipment organized and secured while the device is in transit.

It is therefore an object of the present invention to provide a security box for fishing rods and equipment that has all of the advantages of the prior art and none of its disadvantages.

It is another object of the present invention to provide a lockable fishing rod box that houses and protects a plurality of fishing rods and reels.

Another object of the present invention is to provide a fishing rod lock box that is mountable to a larger structure, such as a vehicle, a fishing dock or a boat.

Yet another object of the present invention is to provide a fishing rod organizer and lock box that is easily transported in a vehicle or on a boat.

Still another object of the present invention is to provide a lockable box for securing fishing rods in between uses, which is capable of securely holding tackle boxes of various sizes and shapes.

A further object of the present invention is to provide a set of cushioned inserts that surround and protect the shaft of a fishing rod during transport in a lock box.

A still further object of the present invention is to provide a portable fishing rod lock box that offers durable and resilient construction to reduce the risk of theft of the contents of the box.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the of the rod lock box, including a single fishing rod and reel.

FIG. 2 shows a rear perspective view of the first embodiment of the rod lock box, including a single fishing rod and reel.

FIG. 3 shows an overhead perspective view of the interior of the box as a tackle box is being inserted into the tackle box holder.

FIG. 4A shows a frontal view of an exemplary embodiment of a cushioned insert.

FIG. 4B shows a side view of an exemplary embodiment of a cushioned insert.

FIG. 5 shows a front view of the lock box with the lid in the closed position.

### DETAILED DESCRIPTION OF THE INVENTION

Reference is made herein to the attached drawings. Like reference numerals are used throughout the drawings to depict like or similar elements of the security box for fishing rods. For the purposes of presenting a brief and clear description of the present invention, the preferred embodiment will be discussed as used for securing fishing rods and equipment when it is not in use. The figures are intended for representative purposes only and should not be considered to be limiting in any respect.

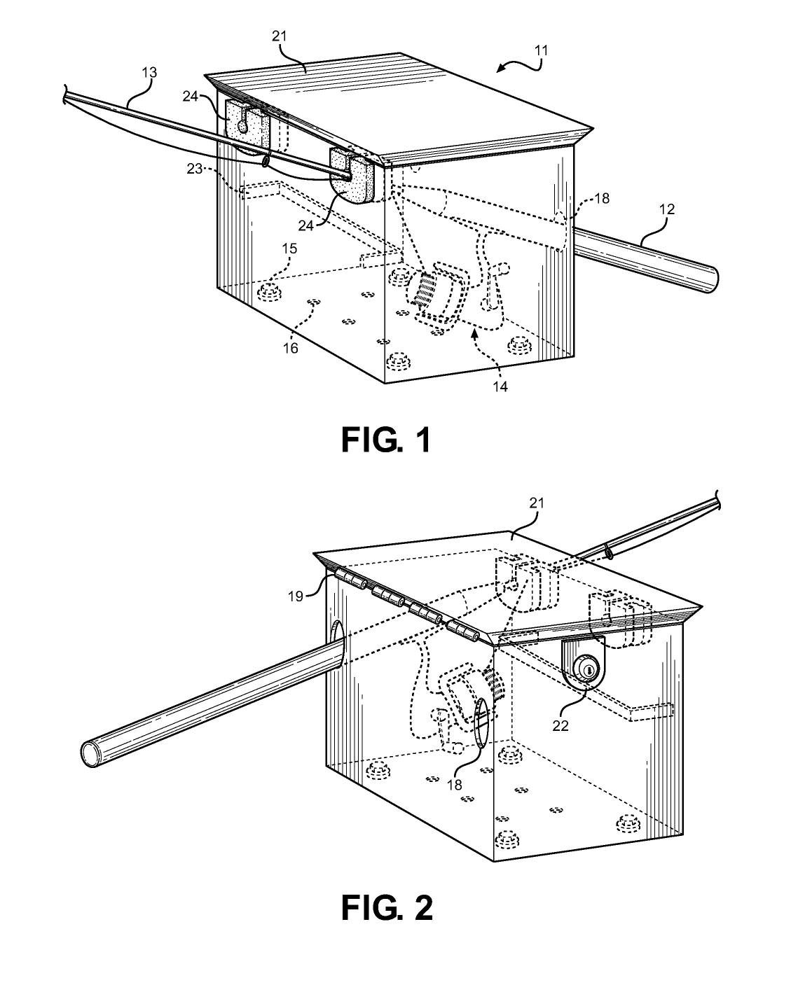

Shown in FIG. 1 is the front and side of the security box 11 for fishing rods. The box has four sidewalls, a bottom and a lid 21, which define an open interior space. Along the inside of the front wall a tackle box holder 23 is attached to facilitate organized storage of tackle trays within the security box interior. Opposing sides of the box have apertures cut out of the sidewall to allow parts of a fishing rod to pass there through.

Along the front of the box there are u-shaped cutout apertures that extend down from an upper edge of the front sidewall. These u-shaped cutouts are used to receive and retain the shaft 13 of a fishing rod, while it is being stored. When the lid is closed, the u-shaped cutout becomes an enclosed space with the lid forming an upper wall of the aperture. This prevents the rod from being jostled out of the u-shaped cutout during storage. As shown in the figure, a plurality of cushioned inserts 24 are slid down into the u-shaped cut-outs to act as a buffer and keep the fishing rod shaft from moving around and colliding with the sides of the u-shaped cutouts. The cushioned inserts thus reduce the potential for damage to the fishing rod from jostling.

The handle of a fishing rod 12 is inserted through any of a plurality of apertures 18 disposed along the back sidewall of the security box. The placement of a rod handle through rear apertures and the rod shaft in the cushioned inserts results in the containment of the fishing rod reel 14 within the interior of the box. When the storage box is in use and the lid is closed and locked, the reel is protected within the box and neither the rod shaft nor the rod handle can be removed from the security box.

To prevent the security box itself from being lifted and carried away without the owner's consent, the box can be affixed to a large object through the use of several mounting holes 16 disposed along the bottom of the box. A secure fastening means 15 such as nut and bolt fasteners can be inserted through the mounting holes to secure the box to an object. To do this, the mounting holes of the box are aligned with holes in a mounting object such as a car or boat, the fasteners are then inserted through the mounting holes of the box and into the mounting object. The fastener is tightened to secure the box in place. For example holes may be drilled into the seat of a boat to allow the box to be bolted down to the boat seat. Unused rods can then be placed within the box and the lid locked down for security. A similar procedure can be completed with the bed of a truck in lieu of a boat seat. This internal securement feature will be appreciated by fishers who wish to leave their equipment in a secure location while it is not in use.

Turning now to FIG. 2, the rear and side of the box is shown. The lid 21 of the security box is attached to the back sidewall by a hinge 19. A lock 22 is used to removably secure the lid to the sidewall and prevent unauthorized access to the interior of the box. The locking mechanism may vary during manufacture but it should be sufficiently strong to prevent the lid of the box from being pried open. Proper locking of the lid to the sidewall of the box is an important part of the invention because it stops would-be thieves from taking fishing rods and equipment out of the box and prevents the entire assembly from being removed from its mounting.

The handle of a fishing rod 12 is shown extending through one of several apertures 18 disposed along the rear sidewall. They may be ovular or circular in shape. Reinforcing material such as rubber or plastic may be used around the perimeter of each aperture to protect the fishing rod handle from collisions with the sides of the aperture. The rear apertures are positioned lower along the rear sidewall than the u-shaped cutouts on the front sidewall. This positioning results in inserted fishing rods being tilted upwards while they are stored in the box. Stored fishing rods that are angled upward will slide backward until the bottom of the reel assembly rests against the back sidewall of the security box. The weight of the reel and handle will pull the reel up against the sidewall and prevent the rod from sliding along the length of the shaft and handle while the security box is in motion. The number of rear sidewall apertures may be greater than or equal to the number of u-shaped cutouts in the front sidewall of the box. This permits fishing rods to be stored within the security box in a variety of positions. Rod positions can be adjusted to provide space for placement of other items within the box. For instance, a spare reel, spools of fishing line, and repair tools may all be stored within the interior space of the box, between fishing rods.

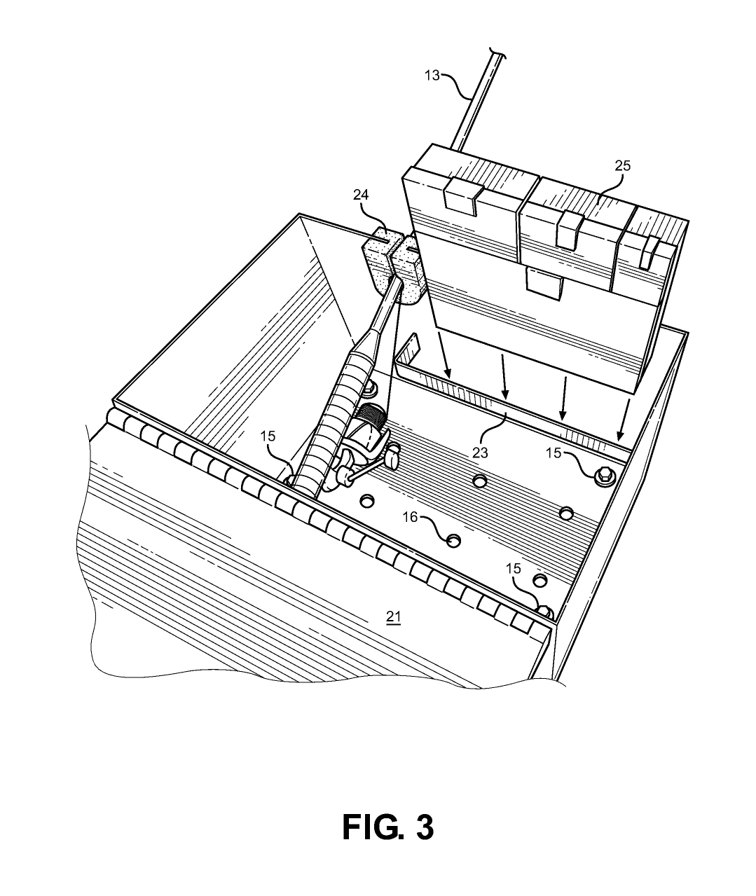

The interior of the box is shown in greater detail in FIG. 3. A cushioned insert 24 is removably secured within a u-shaped cutout and encircles the shaft 13 of a fishing rod. Mounting holes 16 and a plurality of secure fastening means 15 are visible along the bottom of the box. The fasteners may be moved into any of the mounting holes to accommodate mounting setups of different objects. Any mounting holes that are not in use by fasteners are useful as drainage holes,

On the interior of the front sidewall a tackle box holder 23 is affixed. The tackle box holder may be disposed along any sidewall interior of the box and should be positioned between the bottom of the box and half the height of the wall. Positioning the holder lower along the wall provides the ability to hold short or small tackle boxes as well as full-sized trays. The tackle box holder may be a strong wire or a bracket. It should extend slightly away from the sidewall and run in a generally parallel fashion, to create a space between the holder and sidewall. To store a tackle box the user simply slides the box downward along the sidewall until the tackle box is positioned between the sidewall and tackle box holder. Proper storage of tackle within any portable container is important because of the many small items that must stay separated throughout transit. A tackle box is generally used to hold multiple lures, spare hooks, and repair tools. For fly fishermen, a tackle box can also include varieties of thread, feathers, pliers and other fly-making tools. Tackle trays and boxes provide compartments for organizing and separating these different items, to prevent them from becoming entangled. Because many items in a tackle box are sharp, it is important that the tackle stays compartmentalized and separated throughout transit too and from a fishing site, to reduce the risk that a user will injure himself while removing items from the tackle box. The tackle box holder of the present invention facilitates orderly transport of tackle by preventing the tackle box from sliding around within the security box.

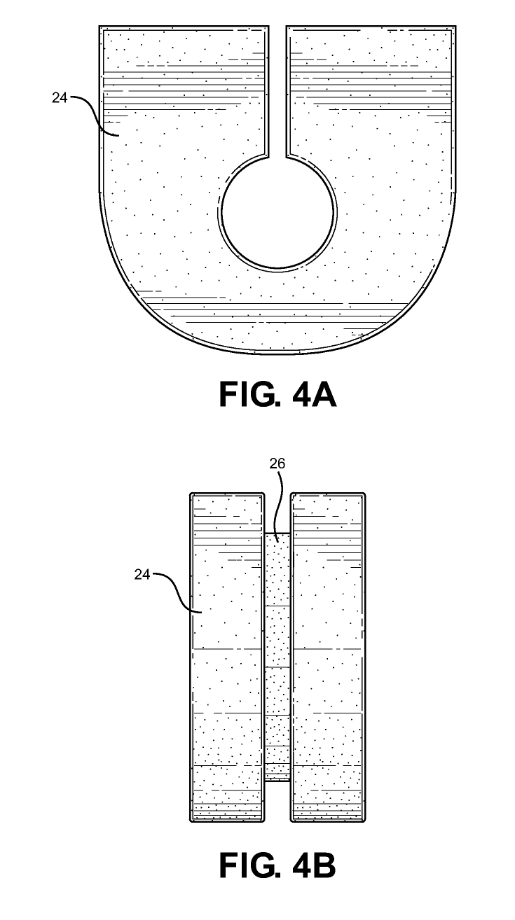

Referring now to FIG. 4A, there is shown a front view of an exemplary cushioned insert. The cushioned insert 24 has a central cutout that is largely circular in shape and an access channel that extends from the top of the insert down to the central cutout. The top of the insert is preferably flat to allow the lid of the security box to close and lock. A lower portion of the insert is an inverted u-shape, forming a convex curved side and bottom edge. Alternatively the cushioned insert may be square with four flat edges. A side channel 26 is shown in FIG. 4B and extends around the entire perimeter of the cushioned insert 24. The side channel has a width slightly greater than the width of the front sidewall of the security box. In either embodiment of the cushioned insert, the side channel has an inverted u-shape so that it mates with the u-shaped cutouts. Thus, the insert removably engages with a u-shaped cutout by aligning the side channel with the edges of the u-shaped cutout and sliding the insert downward until it fits snuggly within the cutout. Fishing rods can then be inserted by pressing the shaft of the rod downward through the access channel of the insert into the central cutout region. An in use depiction of this positioning is shown in FIG. 3. The cushioned insert holds the shaft of the rod steady, preventing it from banging into the walls of the u-shaped cutout. This protection is important for lightweight and thin rods, which can be easily damaged by jostling.

The present security box invention includes a set of cushioned inserts. The number and style of inserts included will depend on the manufacture of the device. Individual inserts will vary to accommodate different types of fishing rods. For example, an insert for a deep-sea rod will have a larger central cutout than an insert for a surf rod. Likewise, a fly fishing rod may have a small central cutout and more padding to further cushion the thin rod shaft. An insert for an ice fishing rod may have an ovular central cutout because these rods are generally not completely circular in diameter. Inserts can easily be inserted into a u-shaped cutout, removed, and exchanged with other inserts. In this manner, the set of cushioned inserts provides a customizable security box that can offer protection to a variety of fishing rod types. The inserts can be exchanged quickly, requiring little effort by a user. The set of inserts included with the box will consist of multiple inserts of one or more varieties. In a preferred embodiment the set will include both surf rod inserts and deep-sea rod inserts as these are two of the most commonly used fishing rod types. Alternative manufacturing options may include one or more of each type of insert. Inserts may be sold separately to permit users to obtain the protection specific to their needs.

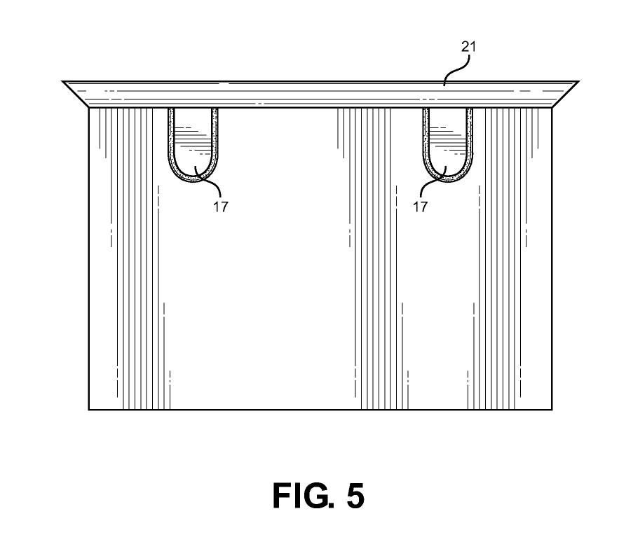

The front of the box is shown in FIG. 5, which provides a clear depiction of the u-shaped cutouts. The u-shaped cutouts 17 are disposed along the front sidewall of the security box and extend downward from an upper edge of the wall. Like the rear sidewall apertures (not shown)) the u-shaped cutouts may be reinforced with rubber or plastic molding around the edges. This molding provides cushioning to fishing rod shafts that are inserted into the cutouts without the use of a cushioned insert. The number of u-shaped cutouts and height of the cutouts can vary to allow manufactures to offer multiple sizes of the security box. It is important that the width of the u-shaped cutout is sufficient to receive a fishing rod but is not wide enough to permit a reel or rod handle to pass through the cutout. Preventing a reel from passing through the cutout ensures that the reel remains safely trapped within the interior of the security box.

In use an individual uses the device to store, transport, and protect a plurality of fishing rods and reels. The device allows a user the ability to secure the box to a base structure using the four mounting locations. These locations are holes in the base that allow a threaded bolt or lock bolt to be placed through the base to secure the entire assembly to a larger structure. The mounting structure can be a boat or motor vehicle, particularly the bed of a pickup truck, or it can be a stationary structure such as a building, fishing dock or storage facility for fishing equipment. The mounting points allow accessibility to the bolts only from within the interior cavity of the box, which can be locked to prevent unauthorized access. Therefore, the box may be rigidly mounted to prevent theft of the assembly or its contents. Once the security box is mounted to an object a tackle box may be slid into a position between the tackle box holder and the sidewall of the box, to prevent it from sliding around during transit. The user then selects appropriate cushioned inserts from the set of inserts and pushes them down into u-shaped cutouts until the cushioned inserts are snuggly in place. The handle of a fishing rod is then inserted through one of the plurality of apertures in the rear sidewall and slid backward until the rod shaft is positioned over a cushioned insert. The rod shaft is pressed downward to push it through the access channel of the insert and down into the central cutout for retention. After all fishing rods and equipment are inserted, the user closes the lid of the box and locks it to prevent unauthorized access to the fishing equipment contained therein.

The box itself may be constructed of any material that prevents easy access to its interior when locked. This may include metallic material such as aluminum or steel, or heavy duty plastic, similar to a toolbox or other type of security box. The number of fishing rods stored within the box is dependent on the size of the box and the number of cutouts provided thereon. The size and number of rods can be any number suitable for the user, including a very large box that holds a number of fishing rods to a smaller box that only houses a few rods.

The lid of the box may include a handle (not shown in the figures). The handle may be of any type known in the art and may have a grip or coating. A handle facilitates easy carrying of the box from one securing location to another securing location. The security box should at all times be firmly secured to an object unless the box is being carried to another area for securing to a new object. It is not intended that the device be used merely for carrying fishing rods and equipment as there are other rod boxes that are better suited to that use. The present invention provides a means for securing fishing rods that are not in use to reduce the likelihood of theft. Alternatively, the box may have no handle. This implementation of the box would be desirous for users who wish to permanently install the security box within the bed of a truck or on a boat. It is essential to the understanding of the present invention that the primary purpose of security is emphasized. In either embodiment the device allows users to secure their fishing rods and go to lunch, get gas, or enter a shop without being concerned that their fishing equipment is vulnerable to theft.

The lock mechanism may be any suitable device to keep the lid and body of the box mated, and prevent unauthorized access. A clasp and hook mechanism for an external pad lock, a turnkey locking device, a combination lock, and any other box locking means known in the art may be used.

Unused mounting holes along the bottom of the box and the large cutouts along the sides that accommodate the fishing rods allow moisture and fluid to escape the box, preventing corrosion and rust of the interior equipment. It is common for fishing rods to become wet after use. Therefore drainage and proper venting is required to prevent the interior of the device from trapping moisture, which can cause serious mechanical problems for the reels or damage to the rods if left for long periods of time.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fishing rod lock box for storing and transporting a plurality of fishing rods, comprising:
a box having four sidewalls, a bottom, and a hingedly attached lid, wherein one of said sidewalls is a front sidewall and another is a rear sidewall;
a plurality of u-shaped cutouts extending downward from an upper edge of said front sidewall;
a plurality of apertures disposed along said rear sidewall;
a lock that removably secures said lid to one of said sidewalls;
a plurality of mounting holes disposed along said bottom;
a plurality of securing fasteners, removably inserted through said mounting holes and engaging with an underlying mounting object;
a set of cushioned inserts, wherein each of said inserts has an inverted u-shaped side channel that engages with said u-shaped cutouts to hold said insert in place within said cutout, and wherein each of said cutouts has a central cutout and an access channel extending between an edge of said insert and said central cutout to receive and retain a shaft of a fishing rod.

2) The security box of claim 1, further comprising:
a tackle box holder disposed along an interior of a sidewall.

3) The security box of claim 2, wherein said tackle box holder extends away from and parallel to said sidewall to permit insertion of a tackle box in between said tackle box holder and said sidewall.

4) The security box of claim 1, wherein said u-shaped cutouts and said plurality of apertures are reinforced.

5) The security box of claim 1, wherein access to said security fasteners is only available from within said box.

6) The security box of claim 1, wherein said set of cushioned inserts includes multiple types of inserts, each type being adapted to receive and retain a different style of fishing rods.
